(19) United States
(12) Patent Application Publication
(10) Pub. No.: US 2016/0105032 A1
(43) Pub. Date: Apr. 14, 2016

(54) WIRELESS POWER RECEPTION DEVICE AND ELECTRONIC DEVICE INCLUDING THE SAME

(71) Applicant: Samsung Electro-Mechanics Co., Ltd., Suwon-si (KR)

(72) Inventors: Sang Ho CHO, Suwon-si (KR); Yong Woon PARK, Suwon-si (KR); Jae Suk SUNG, Suwon-si (KR); Chang Ik KIM, Suwon-si (KR); Chul Gyun PARK, Suwon-si (KR)

(73) Assignee: Samsung Electro-Mechanics Co., Ltd., Suwon-si (KR)

(21) Appl. No.: 14/656,178

(22) Filed: Mar. 12, 2015

(30) Foreign Application Priority Data
Oct. 10, 2014 (KR) 10-2014-0136560

(51) Int. Cl. H02J 5/00; H02J 7/02

(52) U.S. Cl. CPC H02J 5/005; H02J 7/025

(57) ABSTRACT

A wireless power reception device may include a plurality of wireless power receiving units receiving power wirelessly, and a plurality of power management units respectively connected to the plurality of wireless power receiving units and outputting charging currents according to a plurality of power control signals by using power received from the plurality of wireless power receiving units.

### CROSS-REFERENCE TO RELATED APPLICATION

This application claims priority to, and the benefit of, Korean Patent Application No. 10-2014-0136560 filed on Oct. 10, 2014, with the Korean Intellectual Property Office, the disclosure of which is incorporated herein by reference.

### BACKGROUND

The present disclosure relates to a wireless power reception device and an electronic device including the same.

Recently, wireless power transmission technologies have been applied beyond cellular phones, smartphones, and the like to large-capacity tablet personal computers (tablet PCs) and the like. The wireless charging of tablets may require a high power level, relative to the power level required in the charging of smartphones. The use of a single wireless charging receiver for this type of mid-capacity wireless charging is disadvantageous in terms of heat and may not guarantee stability.

Patent document 1, as a related art document, relates to a wireless power reception device including a plurality of coils, in which a reception coil having high wireless power reception efficiency is selected and a device is charged using power received through the selected wireless power reception coil.

### RELATED ART DOCUMENT

### (Patent Document 1) Korean Patent Laid-Open Publication No. 10-2013-0102218

### SUMMARY

An aspect of the present disclosure may provide a wireless power reception device in which an output load of a plurality of wireless power receiving units is distributed.

According to an aspect of the present disclosure, a wireless power reception device may include: a plurality of wireless power receiving units receiving power wirelessly; and a plurality of power management units respectively connected to the plurality of wireless power receiving units and outputting charging currents according to a plurality of power control signals by using power received from the plurality of wireless power receiving units.

According to another aspect of the present disclosure, an electronic device may include: a wireless power reception device including a plurality of wireless power receiving units receiving power wirelessly and a plurality of power management units respectively connected to the plurality of wireless power receiving units and outputting charging currents according to a host power control signal by using power received from the plurality of wireless power receiving units; a battery unit charged upon receiving the charging current; and a host control unit providing the host power control signal.

### BRIEF DESCRIPTION OF DRAWINGS

The above and other aspects, features and advantages in the present disclosure will be more clearly understood from the following detailed description taken in conjunction with the accompanying drawings, in which:

FIG. 1 is a perspective view illustrating an appearance of an electronic device including a wireless power reception device according to an exemplary embodiment in the present disclosure;

FIG. 2 is a block diagram illustrating an operation of the wireless power reception device;

FIG. 3 is a block diagram illustrating an electronic device including a wireless power reception device according to an exemplary embodiment in the present disclosure;

FIG. 4 is a block diagram illustrating an electronic device including a wireless power reception device according to an exemplary embodiment in the present disclosure; and

FIG. 5 is a block diagram illustrating an example of a wireless power receiving unit of a wireless power reception device according to an exemplary embodiment in the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

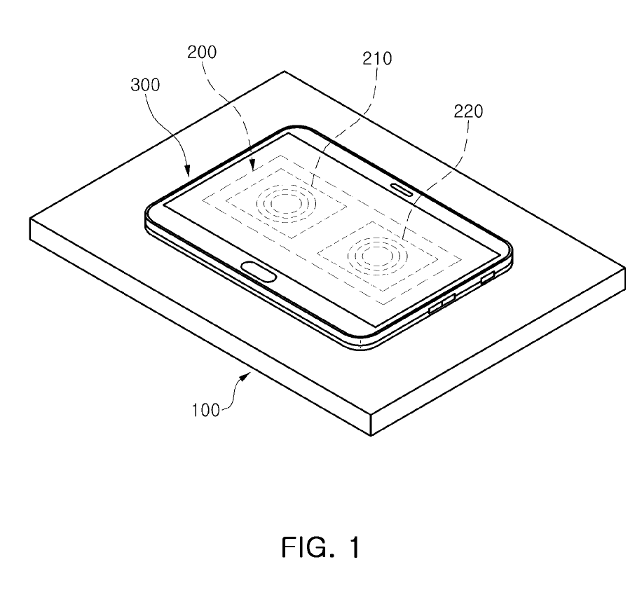

FIG. 1 is a perspective view illustrating an appearance of an electronic device including a wireless power reception device according to an exemplary embodiment in the present disclosure.

Referring to FIG. 1, an electronic device 300 may include a wireless power reception device 200, and the wireless power reception device 200 may include a plurality of wireless power receiving units 210 and 220.

The plurality of wireless power receiving units 210 and 220 may receive power from a wireless power transmission device 100 through inductive coupling or resonant magnetic coupling.

Here, inductive coupling may use the WPC (Wireless Power Consortium) standard, and resonant magnetic coupling may use the A4WP (Alliance for Wireless Power) standard, or any other standard or non-standard scheme may be used.

The wireless power reception device 200 may receive power wirelessly transmitted from the wireless power transmission device 100. Power received by the wireless power reception device 200 may be used for charging a battery (not shown) included in the electronic device 300, or the like.

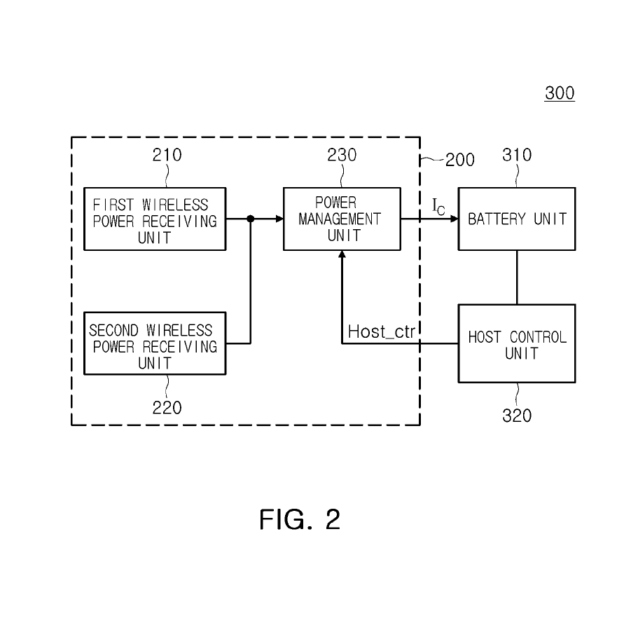

FIG. 2 is a block diagram illustrating an operation of the wireless power reception device.

Referring to FIG. 2, the wireless power reception device 200 may include a first wireless power receiving unit 210, a second wireless power receiving unit 220, and a power management unit 230. The electronic device 300 including the wireless power reception device 200 may further include a battery unit 310 and a host control unit 320.

The first wireless power receiving unit 210 and the second wireless power receiving unit 220 may receive power from the wireless power transmission device 100 through inductive coupling or resonant magnetic coupling.

The received power is transmitted to the power management unit 230, and the power management unit 230 may output charging current I_{c} to the battery unit 310 according to a host power control signal Host_ctr. Although not shown, the input power transmitted to the power management unit 230 may also be supplied as operation power of a camera, a backlight, a display, and the like, included in the electronic device 300.

The power management unit 230 may include a controller, a plurality of DC/DC converters, and a plurality of low drop out (LDO) regulators.

Hereinafter, among functions of the power management unit 230, the output of the charging current I_{c} using power received from the plurality of wireless power receiving units will be mainly described.

The host power control signal Host_ctr received by the power management unit 230 may include current information, voltage information, and output control information, and may be provided from the host control unit 320.

The host control unit 320 may check the current state of the battery unit 310 and determine a power request value of the battery unit 310, and after the determination, the host control unit 250 may provide the power request value as the host power control signal Host_ctr to the power management unit 230 and control the power management unit 230 to output a charging current corresponding to the power request value.

The host control unit 320 may be included in an application processor (AP) included in the electronic device 300.

On the assumption that the current information included in the host power control signal Host_ctr is set to 2 A (ampere), if it is impossible to divide a load between the first wireless power receiving unit 210 and the second wireless power receiving unit 220, a current output from the first wireless power receiving unit 210 may be 1.7 A and a current output from the second wireless power receiving unit 220 may be 0.3 A.

Such unbalance in power may lead to unbalance of output power of the wireless power receiving units, degrade efficiency, and increase heating.

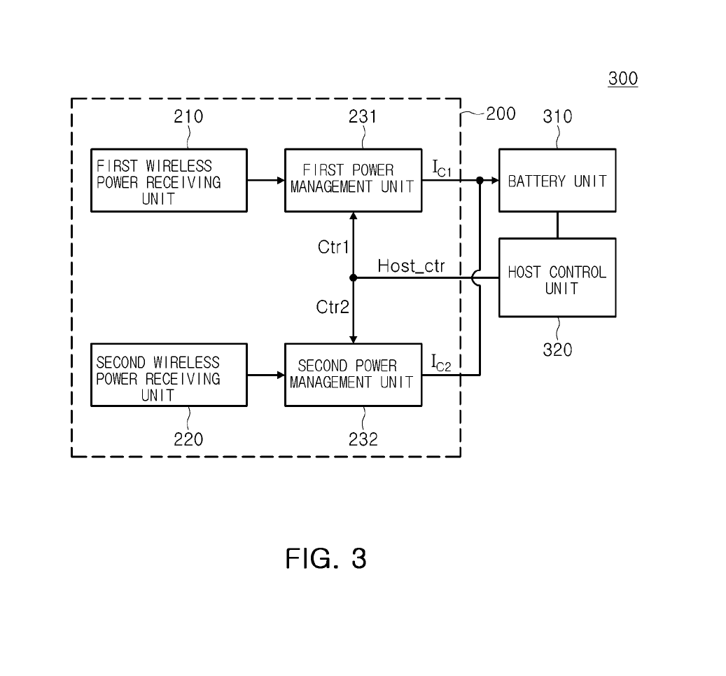

FIG. 3 is a block diagram illustrating an electronic device including a wireless power reception device according to an exemplary embodiment in the present disclosure.

Referring to FIG. 3, the wireless power reception device 200 according to the present exemplary embodiment may include a first wireless power receiving unit 210, a second wireless power receiving unit 220, a first power management unit 231, and a second power management unit 232, and an electronic device 300 including the wireless power receiving unit 200 may further include a battery unit 310 and a host control unit 320.

In FIG. 3, two wireless power receiving units 210 and 220 are illustrated, but the wireless power reception device 200 according to an exemplary embodiment in the present disclosure may include three or more wireless power receiving units according to a power request value of the electronic device 300.

The first wireless power receiving unit 210 and the second wireless power receiving unit 220 may receive power from the wireless power transmission device 100 through inductive coupling or resonant magnetic coupling.

Power received by the first wireless power receiving unit 210 may be transmitted to the first power management unit 231 connected to the first wireless power receiving unit 210. The first power management unit 231 may output a first charging current I_{c1} according to a first power control signal ctr1 using the received power.

Also, power received by the second wireless power receiving unit 220 may be transmitted to a second power management unit 232 connected to the second wireless power receiving unit 220. The second power management unit 232 may output a second charging current I_{c2} according to a second power control signal ctr2 using the received power.

The plurality of power control signals ctr1 and ctr2 received by the first power management unit 231 and the second power management unit 232 may include current information, voltage information, and output control information and may be provided from the host control unit 320.

The host control unit 320 checks the current state of the battery unit 310 to determine a power request value of the battery unit 310, and determine current information included in host power control signal Host_ctr according to the power request value and the number of the plurality of power management units 231 and 232 included in the wireless power reception device 200

Meanwhile, the plurality of power control signals ctr1 and ctr2 may be signals the same as the host power control signal Host_ctr, and the host power control signal Host_ctr may include the plurality of power control signals ctr1 and ctr2.

When a power request value is 2 A and, as illustrated in FIG. 3, the number of power management units is 2, the host control unit 320 may determine current information included in the host power control signal Host_ctr, as 1 A. Accordingly, current information included in the plurality of power control signals ctr1 and ctr2 may be set to 1 A, and both the first power management unit 231 and the second power management unit 232 may output the same current equal to 1 A. That is, a load is divided by the plurality of power management units 231 and 232 respectively connected to the first wireless power receiving unit 210 and the second wireless power receiving unit 220, and thus, the first wireless power receiving unit 210 and the second wireless power receiving unit 220 may output the same current equal to 1 A.

Accordingly, in the electronic device having a high power request value, since the plurality of wireless charge receiving units distributing an output load is disposed, a heating source within the electronic device may be distributed, the wireless power reception device may be reduced in thickness, and power may be stably output according to a power control signal.

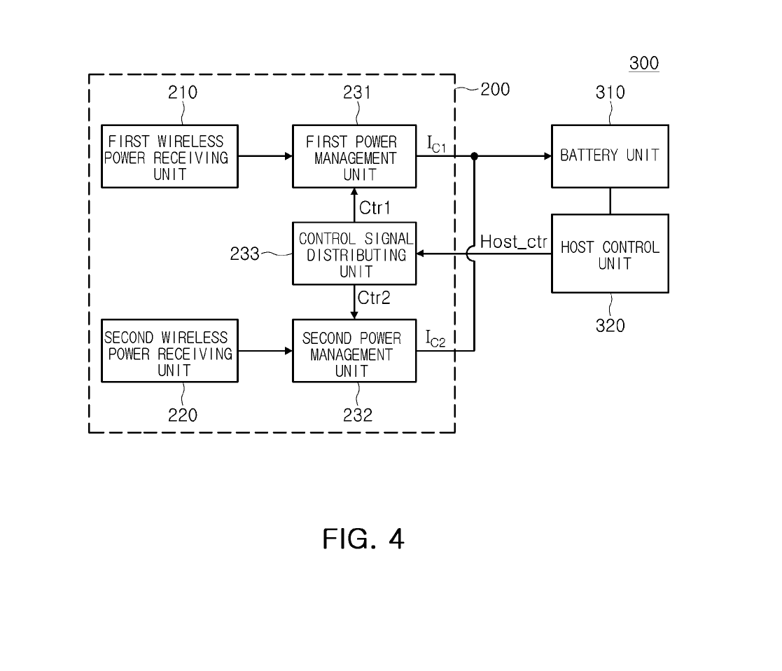

FIG. 4 is a block diagram illustrating an electronic device including a wireless power reception device according to an exemplary embodiment in the present disclosure.

Referring to FIG. 4, a wireless power reception device 200 according to the present exemplary embodiment may include a first wireless power receiving unit 210, a second wireless power receiving unit 220, a first power management unit 231, a second power management unit 232, and a control signal distributing unit 233. An electronic device 300 including the wireless power receiving unit 200 may further include a battery unit 310 and a host control unit 320.

Components other than the added control signal distributing unit 233 may be the same as those of the electronic device 300 including the wireless power reception device 200 described above, and thus, redundant descriptions thereof will be omitted.

The host control unit 320 may check the current state of the battery unit 310 to determine a power request value of the battery unit 310, and provide the determined power request value as a host power control signal Host_ctr to the control signal distributing unit 233.

Here, the control signal distributing unit 233 may receive the host power control signal Host_ctr, determine current information according to the number of the plurality of power management units 231 and 232, generate a plurality of power control signals ctr1 and ctr2, and distribute the plurality of generated power control signals ctr1 and ctr2 respectively to the plurality of power management units 231 and 232.

Current information included in the plurality of power control signals ctr1 and ctr2 provided to the plurality of power management units 231 and 232 may have the same current value.

For example, when a power request value is 2 A, the host control unit 320 may set current information included in the host power control signal Host_ctr to 2 A, and output the host power control signal Host_ctr. As illustrated in FIG. 4, when the number of power management units is 2, the control signal distributing unit 233 determines current information as 1 A, generates a plurality of power control signals ctr1 and ctr2 including the current information, and distributes the plurality of power control signals ctr1 and ctr2 to the first power management unit 231 and the second power management unit 232. Accordingly, the first power management unit 231 and the second power management unit 232 output the same current equal to 1 A.

Accordingly, since the plurality of power control signals ctr1 and ctr2 having the distributed current value are provided to the plurality of power management units 231 and 232 without additional setting of the host control unit 320 included in the electronic device 300, compatibility of the wireless power reception device may increase.

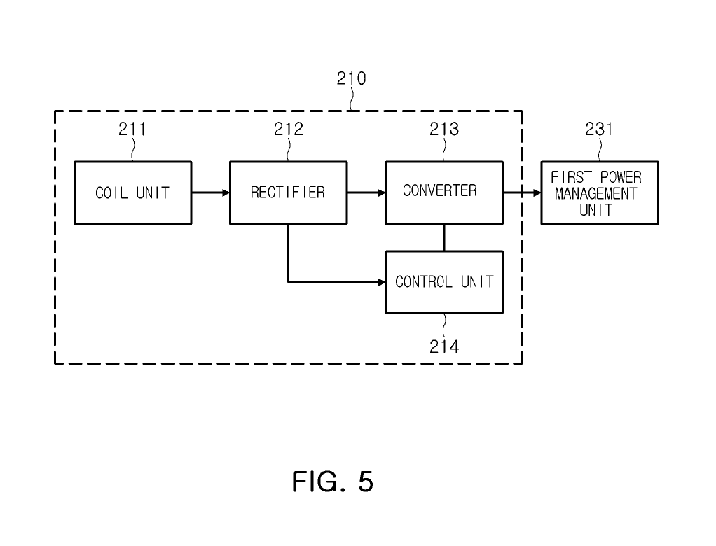

FIG. 5 is a block diagram illustrating an example of a wireless power receiving unit of a wireless power reception device according to an exemplary embodiment in the present disclosure.

Referring to FIG. 5, a first wireless power receiving unit 210 may include a coil unit 211, a rectifier 212, a converter 213, and a control unit 214.

The coil unit 211 may receive wireless power transmitted from the wireless power transmission device 100 through inductive coupling or resonant magnetic coupling described above.

Thereafter, power provided from the coil unit 211 may be rectified by the rectifier 212, the rectified power may be converted by the converter 213 to be the converted power having an output voltage, and the output voltage may be transmitted to a first power management unit 231.

The first power management unit 231 receives the power having the output voltage output from the converter 213 and, since the first power management unit 231 may be set to have a predetermined load, the first power management unit 231 may adjust a current of power received from the first wireless power receiving unit 210.

When the power provided from the coil unit 211 is equal to or higher than a threshold value, the control unit 214 may control the converter 213 to interrupt the output of the converted power.

As set forth above, according to exemplary embodiments in the present disclosure, the wireless power reception device may be reduced in thickness by employing a plurality of wireless power receiving units, a heating source may be separated by distributing an output load of the plurality of wireless power receiving units, and power may be stably output according to a power control signal.

While exemplary embodiments have been shown and described above, it will be apparent to those skilled in the art that modifications and variations could be made without departing from the scope of the present invention as defined by the appended claims.

What is claimed is:

1. A wireless power reception device comprising:
a plurality of wireless power receiving units receiving power wirelessly; and
a plurality of power management units respectively connected to the plurality of wireless power receiving units and outputting charging currents according to a plurality of power control signals by using the power received from the plurality of wireless power receiving units.

2. The wireless power reception device of claim 1, further comprising a control signal distributing unit receiving a host power control signal to generate the plurality of power control signals, and distributing the plurality of power control signals to the plurality of power management units.

3. The wireless power reception device of claim 2, wherein the plurality of power control signals have the same current value.

4. The wireless power reception device of claim 1, wherein the wireless power receiving unit includes:
a coil unit;
a rectifier rectifying power provided by the coil unit; and
a converter converting the power provided by the rectifier into power having an output voltage and outputting the converted power.

5. The wireless power reception device of claim 4, wherein the wireless power receiving unit further includes a control unit controlling the converter to interrupt the output of the converted power when the power provided by the coil unit has a level equal to or higher than a threshold value.

6. An electronic device comprising:
a wireless power reception device including a plurality of wireless power receiving units receiving power wirelessly and a plurality of power management units respectively connected to the plurality of wireless power receiving units and outputting charging currents according to a host power control signal by using the power received from the plurality of wireless power receiving units;
a battery unit charged upon receiving the charging current; and
a host control unit providing the host power control signal.

7. The electronic device of claim 6, wherein the host power control signal includes a plurality of power control signals, and
the plurality of power management units output the corresponding charging currents in response to the corresponding power control signals, respectively.

8. The electronic device of claim 6, wherein the wireless power reception device further includes a control signal distributing unit receiving the host power control signal to generate the plurality of power control signals,
wherein the plurality of power management units output the corresponding charging currents in response to the corresponding power control signals, respectively.

9. The electronic device of claim 7, wherein the plurality of power control signals have the same current value.

10. The electronic device of claim 6, wherein the wireless power receiving unit includes:
a coil unit;
a rectifier rectifying power provided by the coil; and
a converter converting the power provided by the rectifier into power having an output voltage and outputting the converted power.

11. The electronic device of claim 10, wherein the wireless power receiving unit further includes a control unit controlling the converter to interrupt the output of the converted power when the power provided by the coil unit has a level equal to or higher than a threshold value.
